(19) United States
(12) Patent Application Publication
(10) Pub. No.: US 2025/0298760 A1
(43) Pub. Date: Sep. 25, 2025

(54) Memory Chiplet Architecture

(71) Applicant: SAMSUNG ELECTRONICS CO., LTD., Suwon-si (KR)

(72) Inventors: Li Yang, Austin, TX (US); Chih-Wei Yao, Saratoga, CA (US); Nhon Quach, San Jose, CA (US); Kevin Yee, San Jose, CA (US)

(21) Appl. No.: 19/086,047

(22) Filed: Mar. 20, 2025

Related U.S. Application Data
(60) Provisional application No. 63/568,755, filed on Mar. 22, 2024.
(60) Provisional application No. 63/665,127, filed on Jun. 27, 2024.

(51) Int. Cl. G06F 13/16

(52) U.S. Cl. CPC G06F 13/1684; G06F 2213/16

(57) ABSTRACT

A system and a method are disclosed for improving memory chiplets. In an embodiment, a memory chiplet comprises a memory stack and a base die. The base die includes a thru-silicon via (TSV) coupled to the memory stack, a memory controller coupled to the TSV through a first interface, and a die-to-die (D2D) interconnect. The base die further includes a link layer coupled to the memory controller configured to map a bus interface from the memory controller to a D2D interface of the D2D interconnect. Data mapped by the link layer is transmitted to a second chiplet with a parallel link layer corresponding to the link layer.

### CROSS-REFERENCE TO RELATED APPLICATION

This application claims the priority benefit under 35 U.S.C. § 119(e) of U.S. Provisional Application No. 63/568,755, filed on Mar. 22, 2024 and U.S. Provisional Application No. 63/665,127, filed on Jun. 27, 2024, the disclosures of both of which are incorporated by reference in their entirety as if fully set forth herein.

### TECHNICAL FIELD

The disclosure generally relates to integrated circuits. More particularly, the subject matter disclosed herein relates to improvements to memory chiplets.

### SUMMARY

A major improvement in semiconductor designs is the chiplet, a modular silicon chip that is designed to work with other chiplets to create a larger system. Chiplets are often designed for specific functions, such as memory, processing, or I/O operations. Memory chiplets, which include a base die and a memory stack, are very important to the functionality of a full system. One type of memory chiplet, the high-bandwidth memory (HBM) chiplet provides significant improvements in memory chiplet design.

Recent advances in artificial intelligence (AI) hardware accelerators have highlighted the growing demand for HBM chiplets in order to support data-intensive computations. HBM is preferred over traditional memory architectures due to its high dynamic random-access memory (DRAM) bandwidth (BW), which enables faster data transfer rates. With the evolution of HBM technology, such as HBM4, the total BW in a system is constrained by the number of HBM dies that can be integrated with a superchip. This limitation arises primarily due to the edge size (e.g., beachfront) of a system-on-chip (SoC) compute die, which dictates the number of HBM interfaces that can be accommodated. As future superchips require ever-increasing BW, overcoming these integration challenges is critical.

In traditional HBM structures, the HBM chiplet includes a stack of memory on an HBM base die. The HBM base die includes an HBM physical layer (PHY) which interacts with a second chiplet, such as a system on chip (SoC) chiplet. The second chiplet includes a second HBM PHY and a memory controller to manage the flow of data from the memory stack.

One issue with the above approach relates to scalability for high BW requirements and the ability to adapt to different speeds while maintaining low cost and power efficiency. These constraints limit the feasibility of deploying HBM chiplets in a cost-effective and power-efficient manner, particularly as AI workloads demand increasingly higher memory BW.

To overcome these issues, an approach can improve chip-to-chip connections through use of a die-to-die (D2D) interconnect. The use of a D2D interconnect, such as a UCIe interconnect, can increase the scalability while maintaining low cost and power efficiency. The problem with replacing the HBM PHY with the D2D interconnect is that doing so creates timing issues when data is read directly from the memory stack to the D2D interconnect. Thus, there is a need for improvements in the memory based die to allow for D2D interconnects to be used as the chip-to-chip connections.

To solve the above problems, systems and methods are described herein for a a memory controller in the base die of a memory chiplet. A memory controller can handle DRAM timing, but is not simple to implement as the memory controller outputs data in a protocol that cannot be easily transferred through the D2D interconnect. To solve this problem, a link layer is provided in the memory base die which includes logic that maps between the protocols of the memory controller and the protocols of a D2D interconnect, such as a UCIe interconnect. The second chiplet can also then use a standard D2D interconnect with a parallel link layer to map data from the D2D interconnect to protocols of the chiplet logic.

The above approach provides a scalable and power-efficient solution for integrating HBM chiplets with AI accelerators. Multiple different link layers can be used in the base die to allow for connections with different types of chiplets. If multiple types of chiplets are used at the same time, data can be transferred through different chiplets. If only one type of chiplet ends up being used, a multiplex/de-multiplexer may be eFused to set a data path while also obfuscating the other link layers included in the chiplet design. Other implementations may also include core logic in the base die to provide additional functionality at the memory chiplet and/or remove the need for a second chiplet.

In an embodiment, a chiplet comprises a memory stack; a base die comprising: a thru-silicon via (TSV) coupled to the memory stack; a memory controller coupled to the TSV through a first interface; a die-to-die (D2D) interconnect; and a link layer coupled to the memory controller configured to map a bus interface from the memory controller to a D2D interface of the D2D interconnect to be transmitted over a D2D interconnect to a second chiplet with a parallel link layer corresponding to the link layer.

In an embodiment, the chiplet further comprises a core logic in the base die. The core logic may be one or more of a low power double data rate (LPDDR) logic, a compute logic, an accelerator logic, or an I/O chiplet.

In an embodiment, the memory chiplet further comprises a second memory stack coupled to the TSV.

In an embodiment, the memory chiplet further comprises a second link layer coupled to the memory controller configured to map the bus interface from the memory controller to the D2D interface of the D2D interconnect. In an embodiment, the memory chiplet further comprises a multiplexer coupled to the memory controller and coupled to both the link layer and the second link layer configured to select between the link layer and the second link layer. The multiplexer may be electronically fused around the link layer and the second link layer. In an embodiment, the second link layer is configured to map the bus interface from the memory controller to the D2D interface of the D2D interconnect to be transmitted over the D2D interconnect to a second compute chiplet with a second parallel link layer corresponding to the second link layer. In an embodiment, the memory chiplet is configured to switch between using the link layer when communicating with the first compute chiplet and the second link layer when communicating with the second compute chiplet.

In an embodiment, the memory chiplet further comprises a second link layer coupled to the TSV configured to map a memory interface from the TSV to a D2D interface of the D2D interconnect to be transmitted over a D2D interconnect to a second compute chiplet with a memory controller and a second parallel link layer corresponding to the second link layer.

In an embodiment, the memory stack is a high-bandwidth memory (HBM) stack. In an embodiment, the TSV is a high-bandwidth memory (HBM) 3D PHY.

In an embodiment, a system comprises a memory chiplet comprising: a memory stack; a thru-silicon via (TSV) coupled to the memory stack; a memory controller coupled to the TSV through a first interface; a first die-to-die (D2D) interconnect; and a first link layer coupled to the memory controller and the D2D interconnect configured to map a bus interface from the memory controller to a D2D interface of the D2D interconnect; and a second chiplet comprising: a second D2D interconnect; a core logic; a second link layer coupled to the D2D interconnect and the compute core configured to reverse the map of the first link layer from the D2D interconnect to the compute core; and an interposer or substrate configured to couple the memory chiplet to the compute chiplet.

In an embodiment, a method comprises receiving, at a memory controller in a base die of a chiplet, data from a memory stack of the chiplet through a through-silicon-via; receiving, at a link layer of a base die in the chiplet, a signal in memory controller interface format from the memory controller; mapping the signals from the memory controller interface format to a D2D interface format; sending the signal in the D2D interface format to a D2D interconnect of the base die; and transferring the signal from the chiplet to another chiplet through an interposer or substrate.

In an embodiment, the method further comprises receiving second data at the memory controller from a second memory stack of the chiplet through the through-silicon-via; receiving, at the link layer a second signal in memory controller interface format from the memory controller; mapping the second signal from the memory controller interface format to a D2D interface format; sending the second signal in the D2D interface format to the D2D interconnect; and transferring the second signal from the chiplet to the other chiplet through the interposer or substrate.

In an embodiment, the method further comprises receiving, at the memory controller, second data from the memory stack of the chiplet through the through-silicon-via; receiving, at a second link layer a second signal in memory controller interface format from the memory controller; mapping the second signal from the memory controller interface format to a D2D interface format; sending the second signal in the D2D interface format to the D2D interconnect; and transferring the second signal from the chiplet to the other chiplet through the interposer or substrate.

In an embodiment, the method further comprises receiving the signal at a multiplexer from the memory controller; selecting, by the multiplexer, the link layer from a plurality of link layers; sending, by the multiplexer, the signal to the link layer based on the selecting. In an embodiment, the method further comprises receiving second data from the memory stack of the chiplet through the through-silicon-via; selecting, by the multiplexer, a second link layer from the plurality of link layers; sending, by the multiplexer, the signal to the second link layer based on the selecting; receiving, at the second link layer the second signal; mapping the second signal to the D2D interface format; sending the second signal in the D2D interface format to the D2D interconnect; and transferring the second signal from the chiplet to a third chiplet through the interposer or substrate.

In an embodiment, the method further comprises receiving, at a second link layer, second data from the memory stack of the chiplet through the through-silicon-via; mapping the second signal to a D2D interface format; sending the second signal in the D2D interface format to the D2D interconnect; and transferring the second signal from the chiplet to a third chiplet through the interposer or substrate.

In an embodiment, a method comprises receiving, at a memory controller in a base die of a chiplet, data from a memory stack of the chiplet through a through-silicon-via; transferring the data to a core logic of the base die of the chiplet; computing an output at the core logic; receiving, at a link layer of a base die in the chiplet, the output from the core logic; mapping the signals to a D2D interface format; sending the signal in the D2D interface format to a D2D interconnect of the base die; and transferring the signal from the chiplet to another chiplet through an interposer or substrate. The core logic may be one or more of a low power double data rate (LPDDR) logic, a compute logic, an accelerator logic, or an I/O chiplet.

### BRIEF DESCRIPTION OF THE DRAWING

In the following section, the aspects of the subject matter disclosed herein will be described with reference to exemplary embodiments illustrated in the figures, in which:

FIG. 1 depicts an example memory architecture.

FIG. 2A depicts a first example memory chiplet comprising two memory stacks.

FIG. 2B depicts a second example memory chiplet comprising two memory stacks.

FIG. 2C depicts a third example memory chiplet comprising two memory stacks.

FIG. 3 depicts an example memory architecture comprising a memory chiplet and two other chiplets.

FIG. 4 depicts an example memory architecture comprising a memory chiplet and two other chiplets.

FIG. 5 depicts an example memory chiplet with two separate link layers.

FIG. 6 depicts an example memory chiplet comprising a logic core.

FIG. 7 is a flowchart illustrating a method for mapping HBM channels to a D2D module, according to an embodiment.

FIG. 8 is a block diagram of an electronic device in a network environment 800, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

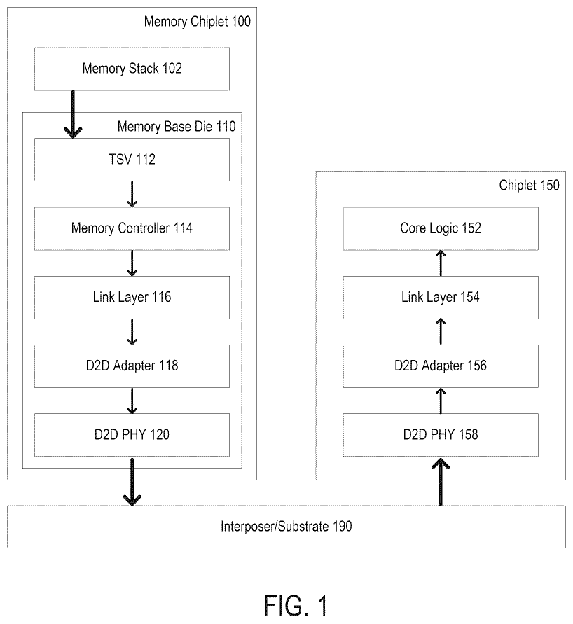

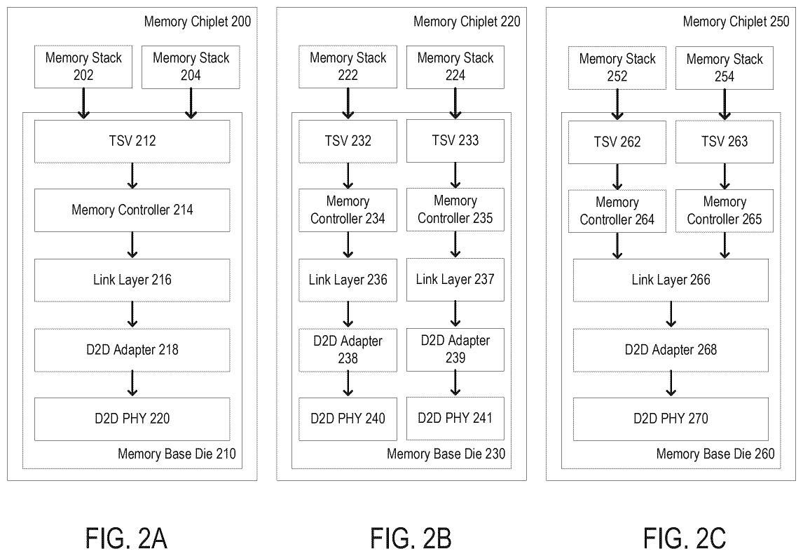

FIG. 1 depicts an example memory architecture. The memory architecture of FIG. 1 comprises a memory chiplet 100 communicatively coupled to a chiplet 150 through an interposer/substrate 190, such as a silicon interposer. Memory chiplet 100 comprises a memory base die 110 and a memory stack 102 comprising one or more memory devices in a vertical stack. In some embodiments, the memory devices in the memory stack comprise high-bandwidth memory (HBM). As will be seen in FIG. 2, memory stack 102 may be a single memory stack or multiple memory stacks.

The memory base die 110 comprises a through silicon via (TSV) 112, a memory controller 114, a link layer 116, and a die-to-die (D2D) interconnect comprising D2D adapter 118 and D2D physical layer (PHY) 120. The TSV 112 comprises an electrical connection that passes through the base die 110 to the memory stack 102. Data from the memory stack 102 may be passed through the TSV 112 to the memory controller 114 using an interface protocol between memory and a memory controller, such as a double-date-rate (DDR) PHY Interface (DFI).

Memory controller 114 comprises a digital circuit that manages the flow of data from the memory stack 102. The memory controller 114 comprises logic for reading the data from memory stack 102 and to output the data through a memory controller interface, such as the Advanced extensible Interface (AXI). The memory controller 114 may be configured to support multiple memory channels and/or multiple memory controllers may be used to support multiple memory channels, such as 32 HBM4 memory channels. For the data from the memory controller to be transferable through the D2D adapter 118 and D2D PHY 120, the D2D adapter 118 needs to receive the data through a D2D interface, such as a Universal Chiplet Interconnect Express (UCIe) interface.

Link layer 116 comprises a digital circuit configured to map data from the memory controller interface to the D2D interface. For example, the link layer may be configured to map data from AXI to a Flow Control Unit (FLIT)-aware D2D Interface (FDI). An example link layer is described in Patent Application No. ###, filed ###, the entire contents of which is incorporated by reference as if fully set forth herein. Additional circuitry may be provided to monitor and adjust signal integrity and timing across the TSVs to further improve reliability. The link layer may be configured to support multiple memory channels and/or multiple link layers may be used to support multiple memory channels.

D2D adapter 118 comprises an adapter layer that performs management functionality and protocol arbitration and negotiation. D2D PHY 120 comprises a physical layer in a D2D connection. In some embodiments, D2D adapter 118 and D2D PHY 120 comprise a UCIe adapter and UCIe PHY. N HBM channels may be mapped to a single D2D module, and may be repeatedly instantiated and expanded to support multiple HBM channels transferred over multiple D2D modules.

Chiplet 150 comprises a second chiplet that is interposed on interposer/substrate 190 and configured to communicate with memory chiplet 100. The chiplet 150 may be any of a compute chiplet, such as an accelerator die, CPU chiplet, GPU chiplet, AI chiplet, or I/O chiplet. Chiplet 150 includes a D2D interconnect comprising D2D PHY 158 and D2D adapter 156, link layer 154, and core logic 152. D2D PHY 158 comprises a physical layer in a D2D connection. D2D adapter 156 comprises an adapter layer that performs management functionality and protocol arbitration and negotiation.

Link layer 154 comprises a digital circuit configured to map data from the D2D interface to the core logic 152 of chiplet 150. Link layer 154 may be a parallel link layer to link layer 116. A parallel link layer is a link layer that uses the same or similar logic as the first link layer, but in reverse. For example, if link layer 116 is configured to map data from AXI to FDI, a parallel link layer 154 may be configured to map the data from FDI back to AXI. Thus, the logic of link layer 154 may mirror the logic in link layer 116, thereby allowing the core logic 152 to communicate with the memory controller 114 as if the core logic 152 and memory controller 114 were in a same chiplet. Core logic comprises a logic element of chiplet 150, such as compute logic in a compute chiplet, low power double data rate (LPDDR) logic, an accelerator logic, or an I/O chiplet logic.

Embodiments of the disclosure include multiple memory stacks in the memory chiplet 100. Different implementations of providing multiple memory stacks are described in FIG. 2A-2C. The memory chiplets of FIG. 2A-2C may be used in conjunction with corresponding second chiplets as depicted in FIG. 1. FIG. 2A depicts a first example memory chiplet comprising two memory stacks. In the example of FIG. 2A, memory chiplet 200 includes two memory stacks as an example, but other embodiments can extend to any number of memory stacks. In FIG. 2A, memory stacks 202 and 204 communicate with a memory base die 210 by sending data through a single set of TSVs, such as 64 TSVs, to a single memory controller or single set of memory controllers 214, such as a memory controller configured to support 64 HBM4 memory channels or a set of memory controllers configured to support 64 HBM4 memory channels. A single link layer or a single set of link layers 216 then maps the data from the memory controller to the D2D Interface of D2D Adapter 218 which sends the information to a second chiplet through a D2D PHY 219.

FIG. 2B depicts a second example memory chiplet comprising two memory stacks. In the example of FIG. 2B, memory chiplet 220 includes two memory stacks as an example, but other embodiments can extend to any number of memory stacks. In FIG. 2B, each memory stack has its own data flow. Thus, memory stack 222 communicates with memory base die 230 by sending data through TSV 212 to memory controller 234 and memory stack 224 communicates with memory base die 230 by sending data through TSV 233 to memory controller 234. Each memory controller or set of memory controllers communicates with a different link layer or set of link layers to the D2D interconnects. Thus, link layer 236 maps data from memory controller 234 to D2D adapter 238 and D2D PHY 240 and link layer 237 maps data from memory controller 235 to D2D PHY 239 and D2D PHY 241.

FIG. 2C depicts a third example memory chiplet comprising two memory stacks. In the example of FIG. 2C, memory chiplet 250 includes two memory stacks as an example, but other embodiments can extend to any number of memory stacks. In FIG. 2C, each memory stack has its own data flow until the data reaches a single link layer. Thus, memory stack 252 communicates with memory base die 260 by sending data through TSV 262 to memory controller 264 and memory stack 254 communicates with memory base die 260 by sending data through TSV 263 to memory controller 264. Each memory controller or set of memory controllers communicates with a single link layer or set of link layers to the D2D interconnects. Thus, link layer 266 maps data from both memory controller 264 and memory controller 264 to D2D adapter 268 and D2D PHY 270.

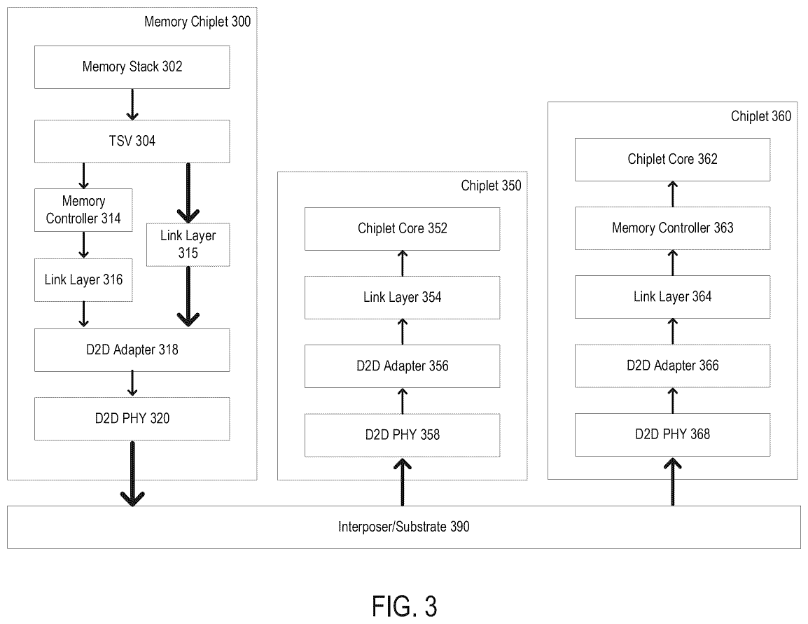

In generating a memory chiplet, it can be beneficial to generate a memory chiplet that is capable of interacting with any chiplet, regardless of whether the chiplet contrains its own memory controller. FIG. 3 depicts an example memory architecture comprising a memory chiplet and two other chiplets. The implementation of FIG. 3 includes a memory chiplet 300 comprising a memory stack 302, TSV 304, memory controller 314, link layer 316, link layer 315, D2D adapter 318, and D2D PHY 320. The memory chiplet 300 is configured to interact with two different types of chiplets. Chiplet 350 does not include its own memory controller while chiplet 360 does include a memory controller. While FIG. 3 depicts both chiplets 350 and chiplet 360 communicating with memory chiplet 300 on interposer/substrate 390, in other embodiments the memory chiplet 300 is configured to communicate with either chiplet 350 or 360 so that when the memory architecture is configured, it can be configured with either chiplet 350 or chiplet 360.

When data from memory chiplet 300 is sent to chiplet 350, the data flows from the memory stack 302 through TSV 304 to memory controller 314. A link layer 316 then maps the data from the memory controller 314 to the D2D adapter 318 and D2D PHY 320 as described previously. Chiplet 350 receives the data through D2D PHY 358 and D2D adapter 356 and a corresponding link layer 354 maps the data to buses of a chiplet core 352 with logic that mirrors the logic in link layer 316.

When data from memory chiplet 300 is sent to chiplet 360, the data flows from the memory stack 302 through TSV 304 directly to link layer 315. Link layer 315 then maps the data from the TSV 304 to the D2D adapter 318 and D2D PHY 320 as described previously. Chiplet 360 receives the data through D2D PHY 368 and D2D adapter 366 and a corresponding link layer 364 maps the data to buses of a memory controller 363. The memory controller 363 may the communicate directly with the chiplet core 362. The implementation of FIG. 3 may also be configured with additional memory stacks in a similar way as in FIG. 2B where the different link layers receive data from different memory stacks. In other embodiments, the implementation of FIG. 3 may be configured with additional memory stacks where the data from each memory stack can be sent through either of the link layers of FIG. 3.

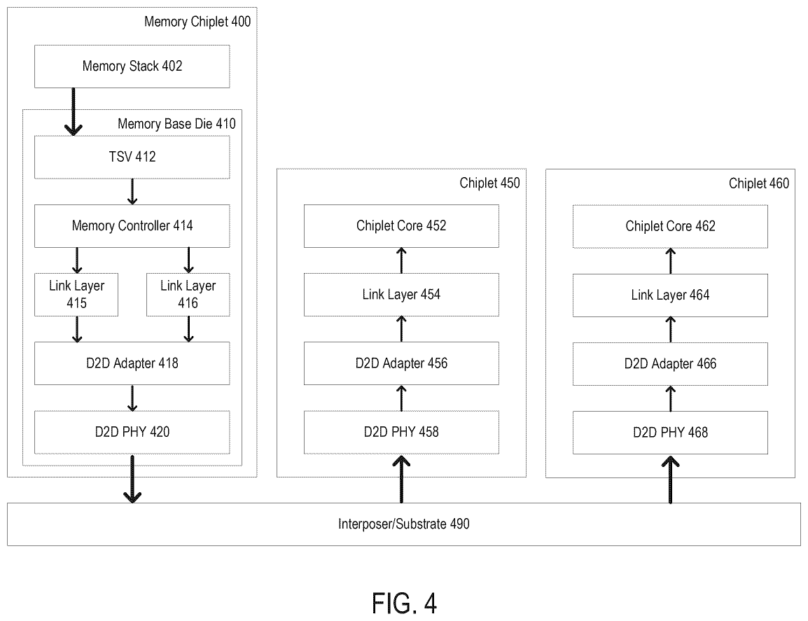

In generating a memory chiplet, it can be beneficial to generate a memory chiplet that is capable of interacting with multiple chiplets that are designed with different logic and/or types of logic. FIG. 4 depicts an example memory architecture comprising a memory chiplet and two other chiplets. FIG. 4 includes a memory chiplet 400 and two other chiplets, chiplet 450 and chiplet 460, both of which communicate through interposer/substrate 490 with memory chiplet 400. The implementation of FIG. 4 includes a memory chiplet 400 comprising a memory stack 402, TSV 412, memory controller 414, link layer 416, link layer 415, D2D adapter 418, and D2D PHY 420. The memory chiplet 400 is configured to interact with two other chiplets. The two other chiplets, chiplet 450 and chiplet 460, both lack a memory controller, but use different types of logic in their link layer and may additionally include different types of chiplet cores. While FIG. 4 depicts both chiplets 450 and chiplet 460 communicating with memory chiplet 400 on interposer/substrate 490, in other embodiments the memory chiplet 400 is configured to communicate with either chiplet 450 or 460 so that when the memory architecture is configured, it can be configured with either chiplet 450 or chiplet 460.

When data from memory chiplet 400 is sent to chiplet 450, the data flows from the memory stack 402 through TSV 412 to memory controller 414. A link layer 415 then maps the data from the memory controller 414 to the D2D adapter 418 and D2D PHY 420 as described previously. Chiplet 450 receives the data through D2D PHY 458 and D2D adapter 456 and a corresponding link layer 454 maps the data to buses of a chiplet core 452 with logic that mirrors the logic in link layer 415.

When data from memory chiplet 400 is sent to chiplet 460, the data flows from the memory stack 402 through TSV 412 to memory controller 414. A second link layer 416, applying different logic as the link layer 415, maps the data from the memory controller 414 to the D2D adapter 418 and D2D PHY 420 as described previously. Chiplet 460 receives the data through D2D PHY 468 and D2D adapter 466 and a corresponding link layer 464 maps the data to buses of a chiplet core 462 with logic that mirrors the logic in link layer 416.

The implementation of FIG. 4 may also be configured with additional memory stacks in a similar way as in FIG. 2B where the different link layers receive data from different memory stacks. In other embodiments, the implementation of FIG. 4 may be configured with additional memory stacks where the data from each memory stack can be sent through either of the link layers of FIG. 4.

In some situations, it may be valuable to provide a memory chiplet that can interact with multiple different chiplets where the logic of the link layers is hidden when the link layer is not used. For example, a chiplet may be manufactured with customized logic for different end users. If the chiplet is manufactured with multiple link layers such that it can interact with the different customized logics, it may be useful to obfuscate logic that is not being used by the chiplet. Thus, the chiplets are able to be mass produced and customized to each use case while keeping link layers that are not used hidden.

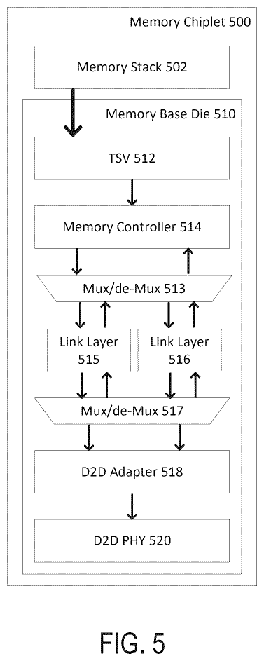

FIG. 5 depicts an example memory chiplet with two separate link layers. FIG. 5 includes a memory chiplet 500 comprising a memory stack 502, TSV 504, memory controller 514, link layer 515, link layer 516, D2D adapter 518, and D2D PHY 520. The memory chiplet includes link layers that are configured to interact with chiplets with corresponding logic. Multiplexer/de-multiplexer (mux/de-mux) 513 and 517 comprise circuits configured to select between link layers 515 and 516. When a chip is built, the mux/de-mux 513 and 517 may be connected to the link layers 515 or 516. An electronic fuse (eFuse) may then be performed on mux/de-mux 513 and 517 to permanently set the configuration of the chip to select between the link layers. In this fashion, the link layer not selected will not be accessible through the memory chiplet. Thus, if link layer 515 is selected and eFused into place, link layer 516 will be inaccessible.

When data is requested from memory stack 502, it will pass through TSV 512 of base die 510 to memory controller 514. The mux/de-mux 513 will pass the data from memory controller 514 to the selected link layer. Which will map the data from the memory controller interface to the D2D interface of D2D adapter 518. The mux/de-mux 517 will pass the data from the selected link layer to D2D adapter 518 and D2D PHY 520. This allows chips to be manufactured with both link layers while configured to communicate with different types of devices.

Placing the memory controller in the memory base die provides benefits in lowering power and increasing scalability. The link layer further provides benefits of allowing the chips to utilize a standard D2D interconnect, such as a UCIe interconnect. In some embodiments, the invention is further improved through placement of core logic in the memory base die, thereby allowing the memory chiplet to operate without a second chiplet or to provide additional functionality at the memory chiplet when operating while connected to a second chiplet. For instance, some tasks can be performed through the logic of the memory chiplet while other tasks are performed through the logic of a connected second chiplet.

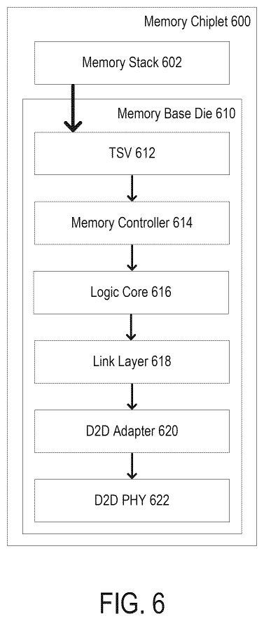

FIG. 6 depicts an example memory chiplet comprising a logic core. Memory chiplet 600 includes a memory stack 602 and memory base die 610. The memory base die 610 comprises a TSV 612, a memory controller 614, a core logic 616, a link layer 618, a D2D adapter 620, and a D2D PHY 622. The TSV 612 comprises an electrical connection that passes through the base die 610 to the memory stack 602. Data from the memory stack 602 may be passed through the TSV 612 to the memory controller 614 using an interface protocol between memory and a memory controller, such as DFI.

Memory controller 614 comprises a digital circuit that manages the flow of data from the memory stack 602. The memory controller 614 comprises logic for reading the data from memory stack 602 and to output the data through a memory controller interface, such as AXI. The memory controller 614 may be configured to support multiple memory channels, such as 32 HBM4 memory channels. The memory controller 614 may be configured to communicate data to core logic 616. Core logic 616 comprises a logic element of the chiplet, such as compute logic in a compute chiplet, low power double data rate (LPDDR) logic, an accelerator logic, network on chip (NoC) logic, or an I/O chiplet logic. Core logic 616 may generate an output based on data received from memory controller 614 and send the output to link layer 618 which maps the output from the core logic 616 to a D2D interface of D2D adapter 620.

D2D adapter 620 comprises an adapter layer that performs management functionality and protocol arbitration and negotiation. D2D PHY 622 comprises a physical layer in a D2D connection. In some embodiments, D2D adapter 620 and D2D PHY 622 comprise a UCIe adapter and UCIe PHY. N HBM channels may be mapped to a single D2D module, and may be repeatedly instantiated and expanded to support multiple HBM channels transferred over multiple D2D modules.

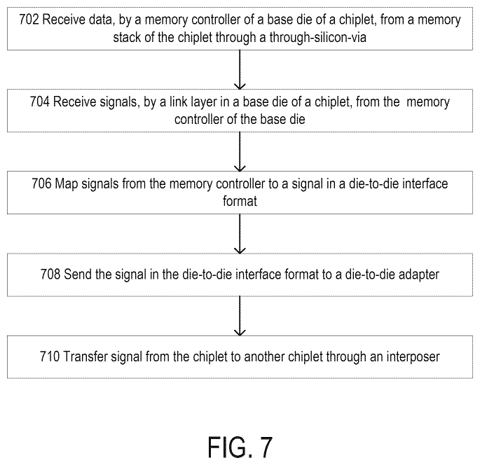

FIG. 7 is a flowchart illustrating a method for mapping HBM channels to a D2D module, according to an embodiment. At 702, a memory controller in a base die of a chiplet receives data from a memory stack of the chiplet through a through-silicon-via. At step 704, a link layer of a base die in a chiplet receives signals in memory controller interface format from the memory controller of the base die. The signals may correspond to HBM channels in the chiplet. The chiplet may be disposed on an interface or substrate of a superchip. The memory controllers may be subset of a plurality of memory controllers of the base die, and the link layer module may be one of a plurality of link layer modules of the base die.

At step 706, the link layer maps the signals to a signal in a D2D interface format. The D2D interface format may be a UCIe interface format. At step 706, the link layer module may send the signal in the D2D interface format to a D2D interconnect of the base die. The D2D interconnect may be a UCIe interconnect. At 718, the D2D interconnect may transfer the signal from the chiplet to another chiplet through an interposer or substrate.

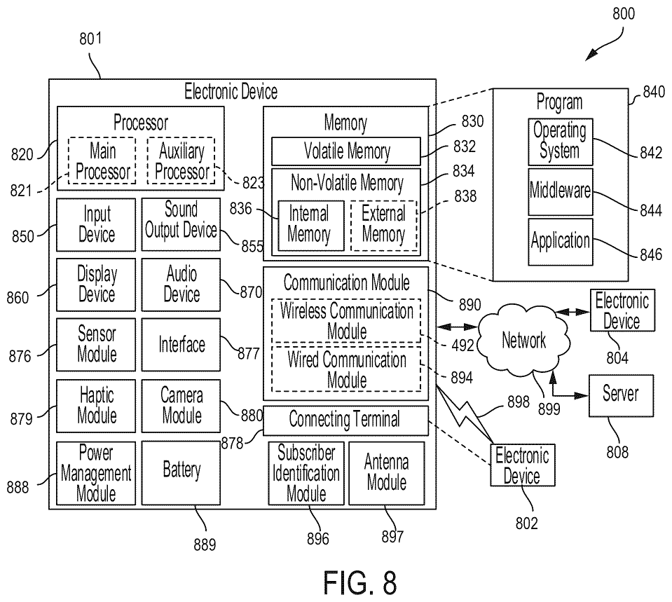

FIG. 8 is a block diagram of an electronic device in a network environment 800, according to an embodiment.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838. External memory 838 may include any of the memory chiplets described in FIG. 1-7.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A memory chiplet comprising:
a memory stack; and
a base die comprising:
a thru-silicon via (TSV) coupled to the memory stack;
a memory controller coupled to the TSV through a first interface;
a die-to-die (D2D) interconnect; and
a link layer coupled to the memory controller configured to map a bus interface from the memory controller to a D2D interface of the D2D interconnect to be transmitted over a D2D interconnect to a second chiplet with a parallel link layer corresponding to the link layer.

2. The memory chiplet of claim 1, further comprising a core logic in the base die.

3. The memory chiplet of claim 2, wherein the core logic is one or more of a low power double data rate (LPDDR) logic, a compute logic, an accelerator logic, or an I/O chiplet.

4. The memory chiplet of claim 1, further comprising a second memory stack coupled to the TSV.

5. The memory chiplet of claim 1, further comprising a second link layer coupled to the memory controller configured to map the bus interface from the memory controller to the D2D interface of the D2D interconnect.

6. The memory chiplet of claim 5, further comprising a multiplexer coupled to the memory controller and coupled to both the link layer and the second link layer configured to select between the link layer and the second link layer.

7. The memory chiplet of claim 6, wherein the multiplexer is electronically fused around the link layer and the second link layer.

8. The memory chiplet of claim 5, wherein the second link layer is configured to map the bus interface from the memory controller to the D2D interface of the D2D interconnect to be transmitted over the D2D interconnect to a third chiplet with a second parallel link layer corresponding to the second link layer.

9. The memory chiplet of claim 8, wherein the memory chiplet is configured to switch between using the link layer when communicating with the second chiplet and the second link layer when communicating with the third chiplet.

10. The memory chiplet of claim 1, further comprising a second link layer coupled to the TSV configured to map a memory interface from the TSV to a D2D interface of the D2D interconnect to be transmitted over a D2D interconnect to a second compute chiplet with a memory controller and a second parallel link layer corresponding to the second link layer.

11. The memory chiplet of claim 1, wherein the memory stack is a high-bandwidth memory (HBM) stack.

12. The memory chiplet of claim 1, wherein the TSV is a high-bandwidth memory (HBM) 3D PHY.

13. A system comprising:
a memory chiplet comprising:
a memory stack;
a thru-silicon via (TSV) coupled to the memory stack;
a memory controller coupled to the TSV through a first interface;
a first die-to-die (D2D) interconnect; and
a first link layer coupled to the memory controller and the D2D interconnect configured to map a bus interface from the memory controller to a D2D interface of the D2D interconnect;
a second chiplet comprising:
a second D2D interconnect;
a core logic; and
a second link layer coupled to the second D2D interconnect and the core logic configured to reverse the mapping of the first link layer from the second D2D interconnect to the core logic; and
an interposer or substrate configured to couple the memory chiplet to the second chiplet.

14. The system of claim 13, wherein the memory chiplet further comprises a second memory stack coupled to the TSV.

15. The system of claim 13, further comprising a third link layer coupled to the memory controller configured to map the bus interface from the memory controller to the D2D interface of the D2D interconnect.

16. The system of claim 15, further comprising a multiplexer, coupled to the memory controller and coupled to both the first link layer and the third link layer, configured to select between the first link layer and the third link layer.

17. The system of claim 16, wherein the multiplexer is electronically fused around the first link layer and the third link layer.

18. The system of claim 15, wherein the third link layer is configured to map the bus interface from the memory controller to the D2D interface of the D2D interconnect, the system further comprising:
a third chiplet comprising:
a third D2D interconnect;
a second core logic; and
a fourth link layer coupled to the third D2D interconnect and the second core logic configured to reverse the mapping of the third link layer from the third D2D interconnect to the second core logic.

19. The system of claim 13, wherein the memory chiplet further comprises a third link layer coupled to the TSV configured to map a memory interface from the TSV to the D2D interface of the D2D interconnect, the system further comprising:
a third chiplet comprising:
a third D2D interconnect;
a second core logic;
a second memory controller; and
a fourth link layer coupled to the third D2D interconnect and the second memory controller configured to reverse the mapping of the third link layer from the third D2D interconnect to the second memory controller.

20. A method comprising:
receiving, at a memory controller in a base die of a chiplet, data from a memory stack of the chiplet through a through-silicon-via;
receiving, at a link layer of a base die in the chiplet, a signal in memory controller interface format from the memory controller;
mapping the signals from the memory controller interface format to a D2D interface format;
sending the signal in the D2D interface format to a D2D interconnect of the base die; and
transferring the signal from the chiplet to another chiplet through an interposer or substrate.
